(19) United States
(12) Patent Application Publication
(10) Pub. No.: US 2007/0143550 A1
(43) Pub. Date: Jun. 21, 2007

(54) Per-set relaxation of cache inclusion

(75) Inventors: Ravi Rajwar, Portland, OR (US); Matthew Mattina, Worcester, MA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/313,114

(22) Filed: Dec. 19, 2005

(51) Int. Cl. G06F 13/28

(52) U.S. Cl. 711/146

(57) ABSTRACT

A multi-core processor includes a plurality of processors and a shared cache. Cache control logic implements an inclusive cache scheme among the shared cache and the local caches for the processors. Counters are maintained to track instances, per set, when a processor chooses to delay eviction from the local cache. While the counter indicates that one or more delayed evictions are pending for a set, the cache control logic treats the set as non-inclusive, broadcasting foreign snoops to all of the local caches, regardless of whether the snoop hits in the shared cache. Other embodiments are also described and claimed.

### BACKGROUND

1. Technical Field

The present disclosure relates generally to information processing systems and, more specifically, to per-set relaxation of cache inclusion for a multiprocessor system.

2. Background Art

A goal of many processing systems is to process information quickly. One technique that is used to increase the speed with which the processor processes information is to provide the processor with a fast local memory called a cache. A cache is used by the processor to temporarily store instructions and data. Another technique that is used to increase the speed with which the processor processes information is to provide the processor with multithreading capability.

For a system that supports concurrent execution of software threads, such as simultaneous multi-threading (“SMT”) and/or chip multi-processor (“CMP”) systems, an application may be parallelized into multi-threaded code to exploit the system's concurrent-execution potential. The threads of a multi-threaded application may need to communicate and synchronize, and this is often done through shared memory. Otherwise single-threaded program may also be parallelized into multi-threaded code by organizing the program into multiple threads and then concurrently running the threads, each thread on a separate logical processor or processor core.

To increase the performance of, and/or to make it easier to write multi-threaded programs, transactional memory can be used. Transactional memory refers to a thread's execution of a block of instructions speculatively. That is, the thread executes the instructions but other threads are not allowed to see the result of the instructions until the thread makes a decision to commit or discard (also known as abort) the work done speculatively.

Processors can make transactional memory more efficient by providing the ability to buffer memory updates done as part of a transaction. The memory updates may be buffered until a decision to perform or discard the transactional memory updates is made. Buffered transactional memory updates may be stored in a cache system.

### Brief Description of the Drawings

Embodiments of the present invention may be understood with reference to the following drawings in which like elements are indicated by like numbers. These drawings are not intended to be limiting but are instead provided to illustrate selected embodiments of systems, methods, apparatuses, and mechanisms to provide per-set relaxation of cache inclusion in a multi-processor computing system.

FIG. 1 is a block diagram illustrating at least one embodiment of a local cache capable of buffering memory updates during transactional execution.

FIG. 2 is a block diagram illustrating at least one embodiment of a multi-core processor.

FIG. 3 is a block data flow diagram illustrating cache processing for a memory write during transactional execution of a sample block of code.

FIG. 4 is a block data flow diagram illustrating cache processing for at least one embodiment of an inclusive cache hierarchy in a multi-core processor.

FIG. 5 is a block diagram illustrating at least one embodiment of a multi-processor system having a modified cache scheme to perform delayed eviction and per-set relaxation of inclusion.

FIG. 6 is a block data diagram showing sample cache operations for a multi-core system having a modified cache scheme to perform delayed eviction and per-set relaxation of inclusion.

FIG. 7 is a flowchart illustrating at least one embodiment of a method for relaxing the inclusion principle in the last-level cache for a set.

FIG. 8 is a block data diagram showing additional sample cache operations for a multi-core system having a modified cache scheme to perform delayed eviction and per-set relaxation of inclusion.

FIG. 9 is a flowchart illustrating at least one embodiment of a method for resuming the inclusion principle in the last-level cache for a set.

### Detailed Description

The following discussion describes selected embodiments of methods, systems and mechanisms to provide per-set relaxation of cache inclusion in a multi-core system. In the following description, numerous specific details such as numbers of processors, ways, sets, and on-clip caches, system configurations, and data structures have been set forth to provide a more thorough understanding of embodiments of the present invention. It will be appreciated, however, by one skilled in the art that the invention may be practiced without such specific details. Additionally, some well known structures, circuits, and the like have not been shown in detail to void unnecessarily obscuring the discussion.

Transactional Execution. For multi-threaded workloads that exploit thread-level speculation, at least some, if not all, of the concurrently executing threads may share the same memory space. As used herein, the term “cooperative threads” describes a group of threads that share the same memory space. Cooperative threads may share some parts of memory space, and may also have access to other, unshared parts of memory as well. Because the cooperative threads share at least some parts of memory space, they may read and/or write to at least some of the same memory items. Accordingly, concurrently-executed cooperative threads should be synchronized with each other in order to do correct, meaningful work.

Various approaches have been devised to deal with synchronization of memory accesses for cooperative threads. One such approach is “transactional execution”, also sometimes referred to as “transactional memory”. Under a transactional execution approach, a block of instructions may be demarcated as an atomic block and may be executed atomically without the need for a lock. (As used herein, the terms “atomic block”, “transactional memory block”, and “transactional block” may be used interchangeably.) Semantics may be provided such that either the net effects of the each of demarcated instructions are all seen and committed to the processor state at the same time, or else none of the effects of some or all of the demarcated instructions are seen or committed.

During execution of an atomic block of a cooperative thread, for at least one known transactional execution approach, the memory state created by the thread is speculative because it is known whether the atomic block of instructions will successfully complete execution. That is, second cooperative thread might contend for the same data, and then it is known that the first cooperative thread cannot be performed atomically. To provide for misspeculation, the processor state is not updated during execution of the instructions of the atomic block, according to at least some proposed transactional execution approaches. Memory updates made during the atomic block may instead be buffered in a local buffer, such as a cache, until it is determined whether the block has been able to successfully execute atomically and, as a result, the memory updates may be architecturally committed to memory. For other approaches, a recovery state is recorded before any processor state updates are made during execution of the instructions of the atomic block. If a misspeculation occurs, the processor state may later be restored from the saved recovery state.

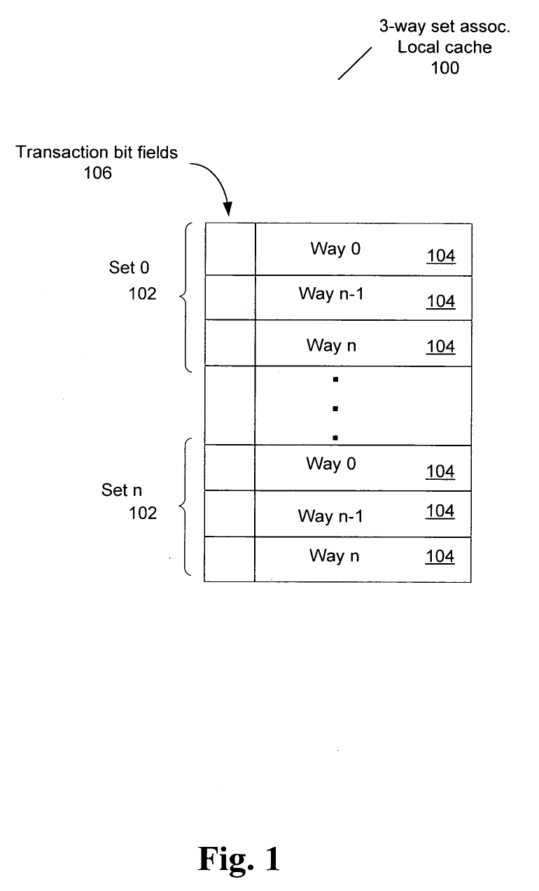

FIG. 1 is a block diagram illustrating at least one embodiment of a local cache 100 capable of buffering memory updates during transactional execution. In many existing systems, a cache 100 is subdivided into sets 102. Each set in many modem processors contains a number of lines 104 called “ways.” Because each set contains several lines, a main memory line mapped to a given set may be stored in any of the lines, or “ways”, 104 in the set.

FIG. 1 illustrates a local cache 100 that includes one or more sets 102, each set containing a number (n) of ways 104. For the sample embodiment illustrated in FIG. 1, each set contains n=3 ways. FIG. 1 illustrates that each way 104 of the cache 100 may be associated with a transaction field 106. The value of the bit in the transaction field 106 may indicate whether the cache line in the way 104 holds speculative data that has been modified during execution of an atomic block. If the bit in the transaction field 106 indicates a value of “1”, for example, this may indicate that the cache line 104 includes speculative (or “interim”) data for a transaction that has not yet completed atomic execution. Such data is not visible to the rest of the system. If another thread (running on the same processor or another processor) attempts to access the cache line while the transaction bit is set, then the transaction must fail because it cannot be performed atomically.

For general cache processing, when a cache miss occurs the line of memory containing the missing item is loaded into the cache 100, sometimes replacing another cache line. This process is called cache replacement. During cache replacement, one of the ways 104 in the set 102 must be replaced and is therefore selected for eviction from the cache 100.

Resource Guarantee. If a transaction requires more cache ways 104 than are available in a set 102 of the cache 100, the transaction will fail for lack of resources because one of ways 104 that holds an interim value will be selected for eviction in order to make way for another of the interim values. Any eviction from the local cache 102 during a transaction will cause the transaction to abort because memory updates from a transaction should be committed (or not) atomically.

In order to avoid this problem, it is desirable to provide application programmers with a “resource guarantee.” That is, if a programmer knows that a certain number of ways are guaranteed to be available for execution of a transactional block, then the programmer may write code that requires, even under a worst-case scenario where all memory accesses of the transactional block map to the same set, only that certain number of cache lines. That is, the programmer may write code that only requires the number of ways available in a set, or that are available in any other manner (such as number of ways available in set plus ways available in a victim cache).

In this manner, the programmer's code is guaranteed not to fail for lack of cache resources. For this reason, the resource guarantee may be very important to application programmers. A programmer's reliance on the resource guarantee can be jeopardized, however, in a multi-processor system that implements an inclusive cache scheme.

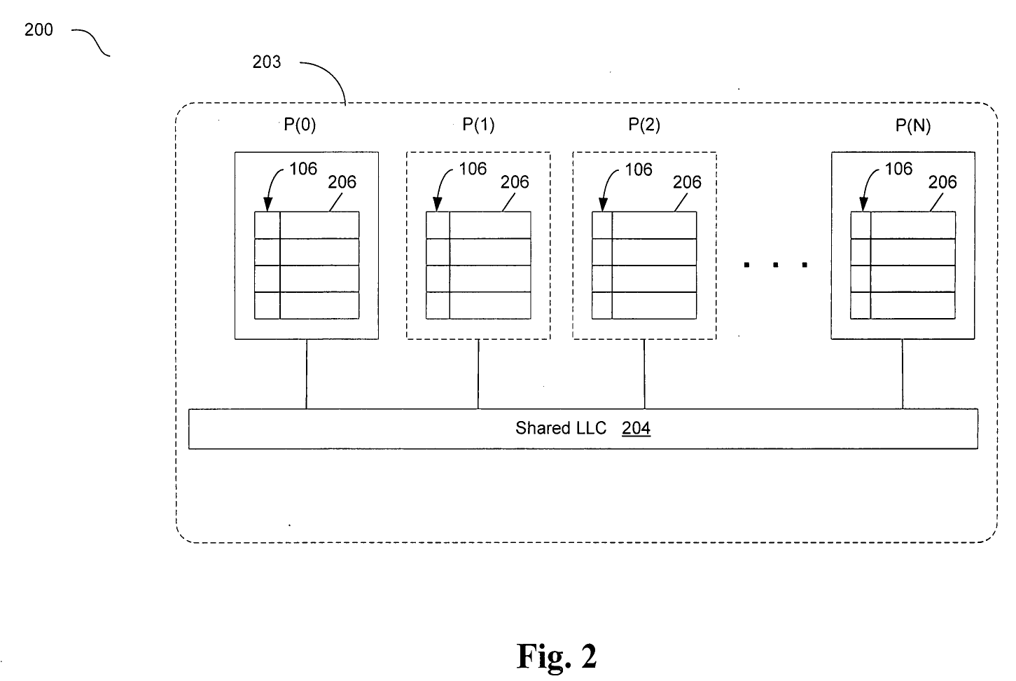

Cache Buffering for Transactional Execution. FIG. 2 is a block diagram illustrating at least one embodiment of a multi-core processor. The processor 200 may include two or more processor cores P(0)-P(N). The representation of four processors, P(0)-P(N), in FIG. 2 should not to be taken to be limiting. For purposes of discussion, the number of processor cores is referred to as “N.” The optional nature of processor cores in excess of two is denoted by dotted lines and ellipses in FIG. 2. That is, FIG. 2 illustrates N≧2. The per-set relaxed inclusion scheme and delayed eviction that are described herein may be performed in any multi-core processor having n processor cores, where n≧2.

For simplicity of discussion, a CMP embodiment is discussed in further detail herein. That is, each processor core P(0)-P(N) illustrated in FIG. 2 may be representative of 32-bit and/or 64-bit processors such as Pentium®, Pentium® Pro, Pentium® II, Pentium® III, Pentium® 4, and Itanium® and Itanium® 2 microprocessors. Such partial listing should not, however, be taken to be limiting.

FIG. 2 illustrates that each processor core P(0)-P(N) of the processor 200 may include one or more local caches. For ease of discussion, only one such cache 206 is illustrated for each processor P1-P4 in the sample system 200 illustrated in FIG. 2. Each of the local caches 206 may include a transaction field as illustrated in FIG. 1 (see, e.g., 106 of FIG. 1).

FIG. 2 illustrates at least one CMP embodiment, with the multiple processor cores P(0)-P(N) and a shared last-level cache 204 residing in a single chip package 103. Each core may be either a single-threaded or multi-threaded processor. The embodiment 200 illustrated in FIG. 2 should not be taken to be limiting, however—the cores P(0)-P(N) need not necessarily reside in the same chip package nor on the same piece of silicon.

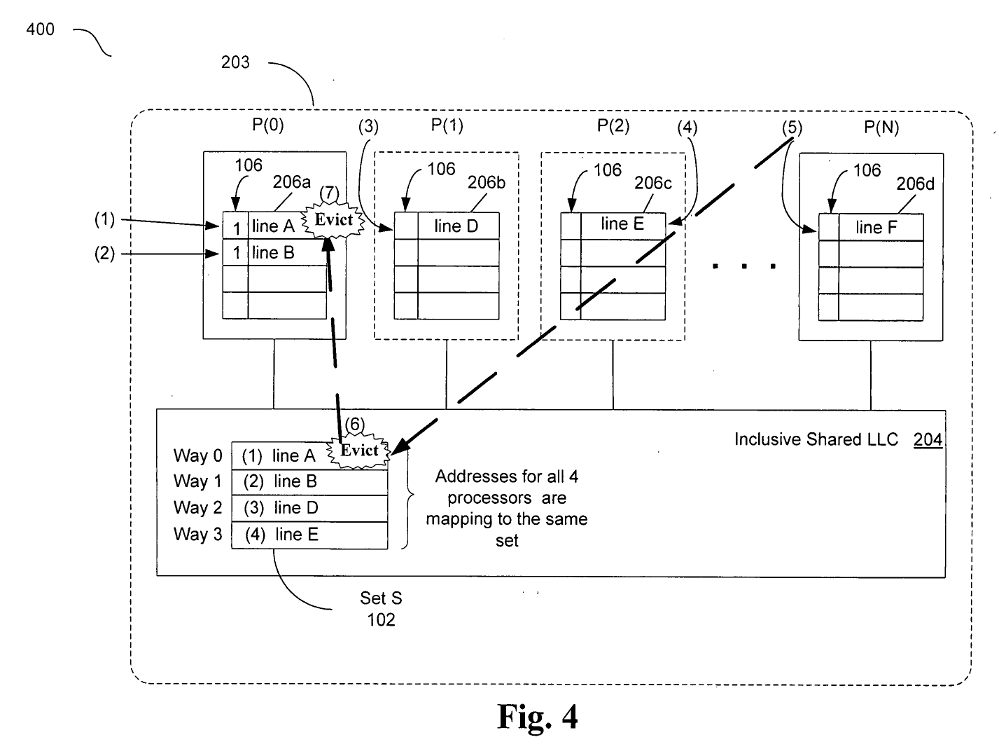

The embodiment of a processor core (P0)-P(N) illustrated in FIG. 2 is assumed to provide certain semantics in support of speculative multithreading. For example, it is assumed that each processor core P(0)-P(N) provides some way to demarcate the beginning and end of a set of instructions (referred to interchangeably herein as an “atomic block” or “transactional block”) that includes a memory operation for shared data. Also, as is discussed above, each processor core P(0)-P(N) includes a local cache 206 to buffer store (memory write) operations. (For at least one embodiment, such mechanism includes the transaction fields 106.) Also, each processor core P(0)-P(N) is assumed to perform atomic updates of the buffered memory writes from the local cache 206 (if no contention is perceived during execution of the atomic block). Such general capabilities are provided by at least one embodiment of the processor cores (P0)-P(N) illustrated in FIG. 2 (as well as the processor cores (P0)-P(N) illustrated in FIGS. 4, 5, 6 and 8, discussed below).

When it is finally determined whether or not the atomic block has been able to complete execution without unresolved dependencies or contention with another thread, then the memory updates buffered in the local cache 206 may be performed atomically. If, however, the transaction fails (that is, if the atomic block is unable to complete execution due to contention or unresolved data dependence), then the lines in the local cache 206 having their transaction bit set may be cleared and the buffered updates are not performed.

During execution of the atomic block, and before the determination about whether it has successfully executed, memory writes may be buffered in the local cache 206 as follows. When a write occurs during transactional execution, the memory line to be written is pulled into a way the local cache 206 from memory (not shown in FIG. 2) and the new value is written to the local cache 206. The transaction bit (see transaction field 106) for the way is set in the local cache 206 order to indicate that the way includes an interim value related to transactional execution.

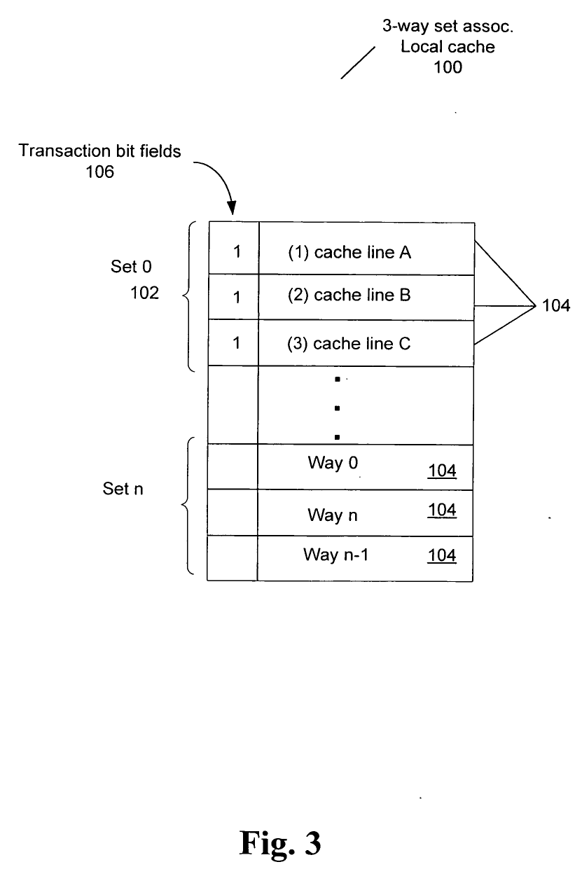

FIG. 3 is a block data flow diagram illustrating cache processing for a memory write during transactional execution. FIG. 3 illustrates a series of cache transactions performed during execution of a sample atomic sequence of instructions. It is assumed for purposes of example that each of the memory writes during the transaction maps to the same set of the local cache 206 but write different cache block addresses. The atomic block of instructions is set forth in the following pseudocode:

Start_transaction XYZ {
(1) Write X
(2) Write Y;
(3) Write Z;
} End_transaction

One benefit of transactional execution is that the memory locations written during an atomic block of instructions need not be contiguous. FIG. 3 illustrates that, for the sample code for transaction XYZ, three memory locations are written—A, B, and C—but for each write a different line of memory is brought into the cache 100. For purposes of example, all of the lines for memory writes during transaction XYZ map to the same set, set) 102, of the cache 100.

FIG. 3 illustrates that a first cache operation (1) brings a line of memory containing data item X into the local cache 206 for the processor that is executing transaction XYZ. The line is referred to as cache line A. The transaction bit in field 106 is set for cache line A to indicate that it contains interim data.

Similarly, a second cache operation (2) brings a line of memory (referred to as cache line B) containing data item Y into the cache 206. Again, the transaction bit in field 106 is set for cache line B. A third cache operation (3) brings cache line C (which contains data item Z) into the local cache 206. Again, the transaction bit in field 106 is set.

Because set 0 102 includes sufficient ways to accommodate all memory writes of transaction XYZ, the transaction will not fail for lack of resources in the cache 100. That is, the resource guarantee is maintained.

Inclusive Caches and Transactional Execution in a Multi-core Processor System.

The use of an inclusive cache hierarchy for multi-core multithreading systems may jeopardize the resource guarantee. FIG. 4, which is a block data flow diagram representing at least one embodiment of an inclusive cache hierarchy in a multi-processor system 400, is utilized to elaborate this point. The sample system 400 illustrated in FIG. 4 employs a write-invalidate cache coherence policy in order to maintain coherence among the local caches 206a-206d.

For an inclusive cache scheme, data present in any local cache 206a-206d is also present in the last-level cache 204. Coherence snoops from outside of the chip 203 need only be sent, initially, to the LLC 204. This may occur, for example, if a snoop request comes from another socket (not shown) outside the chip 203 illustrated in FIG. 4. Such a snoop request is referred to herein as a “foreign” snoop.

If the foreign snoop hits in the LLC 204, then it may be broadcast to one or more of the processors P(0)-P(N) so that the local caches 206a-206n may be queried as well. Otherwise, if the foreign coherence snoop does not hit in the LLC 204, then it is known that the data does not appear in any of the local caches 206a-206d, and snoops need not be sent to the local caches 206a-206d. In this manner, bus traffic related to foreign snoops may be reduced over the mount of such bus traffic expected for a non-inclusive cache hierarchy.

If a cache line is evicted from the LLC 204 for an inclusive cache system, then the cache line must also be evicted from any local cache 206 that contains it. As FIG. 4 illustrates, this means that external events may force eviction of locally-cached data during a transaction, even if the programmer writes the code carefully in order to comply with the resource guarantee.

The example illustrated in FIG. 4 assumes that all memory operations illustrated in FIG. 4 map to the same set of the LLC 204, and that the set 102 is a four-way set. For the example illustrated in FIG. 4, assume that processor core P(0) is executing the code for transaction XYZ set forth above. Also assume that each of the other processors are concurrently executing code as follows:
Processor core P(1): Write M
Processor core P(2): Write N
Processor core P(N): Write P

FIG. 4 illustrates that, at cache operations (1) and (2), processor core P(0) pulls cache lines A and B into its local cache 206a and sets the transaction bits (as explained above in connection with FIG. 3) in field 106. Because the cache hierarchy is inclusive, cache lines A and B are also brought into the LLC 204 during cache operations (1) and (2), respectively.

While processor core P(0) has not yet completed execution of transaction XYZ, core P(1) executes its instruction, causing cache operation (3) to pull cache line D into the local cache 206b into order to write data item M. Also before processor core P(0) has yet completed execution of transaction XYZ, processor core P(2) executes its instruction, causing a cache operation (4) to pull cache line E into the local cache 206c in order to write data item N. Due to the inclusion principle, cache lines D and E are also written to the LLC 204 during cache operations (3) and (4), respectively.

FIG. 4 illustrates that, also before processor core P(0) has completed execution of transaction XYZ, processor core P(N) executes its instruction, causing a cache operation (5) to pull cache line F into the local cache 206d in order to write data item P. [It is immaterial to this discussion whether cache operations (3), (4) and (5) are performed during an atomic transaction on their respective processor cores; therefore FIG. 4 does not indicate a value for the transaction bit associated with cache transactions (3), (4), and (5).]

FIG. 4 illustrates that cache operation (5), executed as the result of execution of the “Write P” operation on processor core P(N), encounters a full set 102 of the LLC 204. That is, each way of the set 102 includes valid data. Accordingly a victim cache line must be selected for eviction as a result of cache operation (5). FIG. 4 illustrates that, for purposes of example, the LLC replacement algorithm selects Way 0 to be evicted.

The eviction at cache operation (6) of line A from the LLC 204 has severe consequences for processor core P(0). Because the cache hierarchy is inclusive, eviction of a cache line from the LLC 204 requires eviction (7) of the same line from the local cache 206a as well. Eviction of cache line A from the local cache 206a at cache operation (7) causes transaction XYZ to abort and fail. This is because all memory operations for an atomic transaction must be updated (or not) to the next level of the cache hierarchy atomically.

Therefore, eviction of cache line A from the local cache 206a of processor core P (0) during cache operation (7) causes transaction XYZ to fail, even though there has been no contention for the data in the local cache 206a by a cooperative thread, and even though processor core P(0) has sufficient resources, according to a four-way guarantee for transactional execution, in its local cache 206a to complete execution of transaction XYZ.

The problem illustrated in FIG. 4 may occur even if the inclusive LLC 204 tracks transaction bits and if the inclusive LLC's replacement algorithm is biased not to evict cache lines whose transaction bit is set. This is true because all cache lines in the LLC set may, at a given time, be marked as interim transactional data.

Relaxed Inclusion and Delayed Eviction.

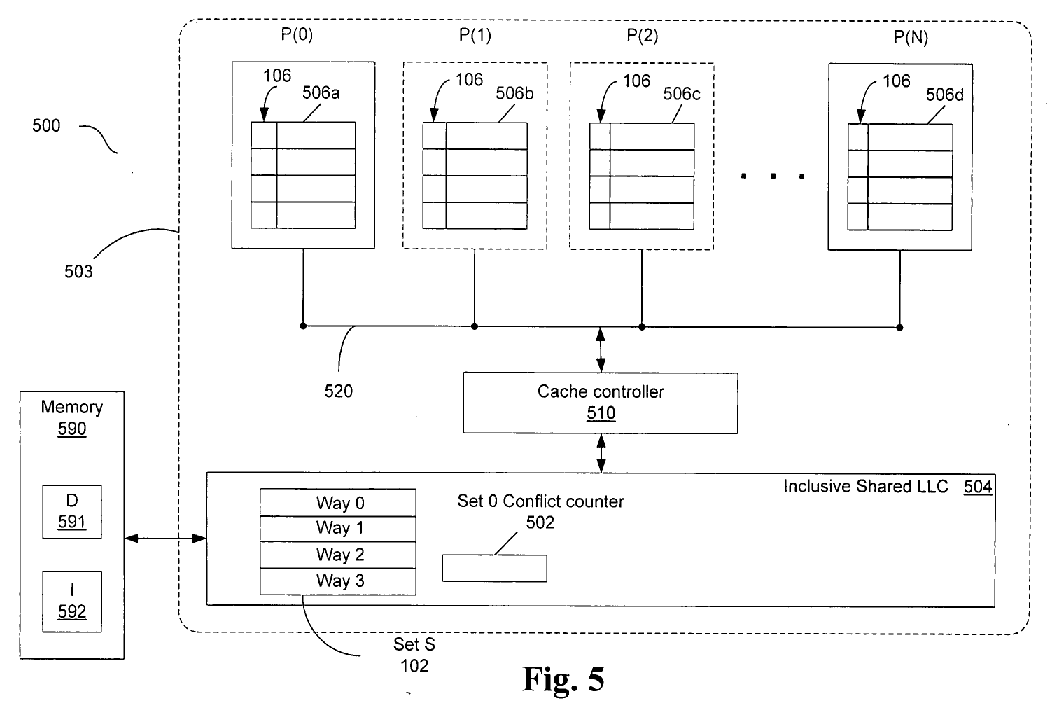

FIG. 5 is a block diagram illustrating a multi-processor system 500 to employ a modified cache scheme, according to at least one embodiment of the invention, to temporarily delay eviction from the local caches 506a-506d and to relax inclusion in the LLC 504 on a per-set basis.

FIG. 5 illustrates that a multi-processor system 500 may include a plurality of processor cores P(0)-P(N). As is discussed above in connection with FIG. 4, the particular number of processor cores illustrated in FIG. 5 should not be taken to be limiting. The relaxed inclusion scheme discussed herein may be utilized for any multi-core system that includes n processor cores, where n≧2. At least some of the processor cores P(0)-P(N) and the LLC 504 may reside in the same chip package 503.

FIG. 5 illustrates that each processor may include a local cache 506a-506n. Each of the local caches 506a-506n may include a transaction field 106 for each cache line as discussed above. FIG. 5 illustrates that the system 500 also includes an inclusive LLC cache 504. The inclusive LLC cache 504 includes a conflict counter 502 for each set (e.g., set 102) of the LLC 504. The conflict counter 502 may be a register, latch, memory element, or any other storage area capable of storing a counter value. For at least one embodiment, if an LLC 504 has x sets, then the system 500 includes x counters 502.

The system 500 may also include a control logic module 510 (referred to herein as “cache controller”) that performs cache control functions such as making cache hit/miss determinations based on memory requests submitted by the processor cores P(0)-P(N) over an interconnect 520. The cache controller 510 may also issue snoops to the processor cores P(0)-P(N) in order to enforce cache coherence.

Accordingly, during normal inclusive processing, we say that all sets of the LLC 504 are in an inclusive mode. If a processor requests data for a memory write, the cache controller 510 may send an invalidating snoop operation to the LLC 504 for that data block. If the snoop operation hits in the LLC 504, the LLC 504 invalidates its copy of the data block. In addition, because the snoop hit in the LLC 504, and because the cache scheme illustrated in FIG. 5 is inclusive, then an invalidating snoop operation is also sent to the L1caches 506a-506nfrom the cache controller 510 over the interconnect 520.

However, the cache controller 510 also includes logic to implement a delayed eviction and inclusion relaxation scheme. For at least one embodiment, the cache controller 510 may utilize a set's conflict counter 502 in order to implement a delayed eviction scheme in order to ensure a resource guarantee of X cache lines for local caches 206 during transactional execution.

The delayed eviction scheme implemented by the cache controller 510 relies on a relaxation of inclusion for any set whose conflict counter 502 holds a non-zero value. That is, the scheme provides the ability for the LLC 504 to be temporarily non-inclusive on a selective per-set basis. While the embodiments discussed herein utilize the counter 502 to reflect that delayed evictions are pending for a set, any other manner of tracking pending delayed evictions may also be utilized without departing from the scope of the appended claims.

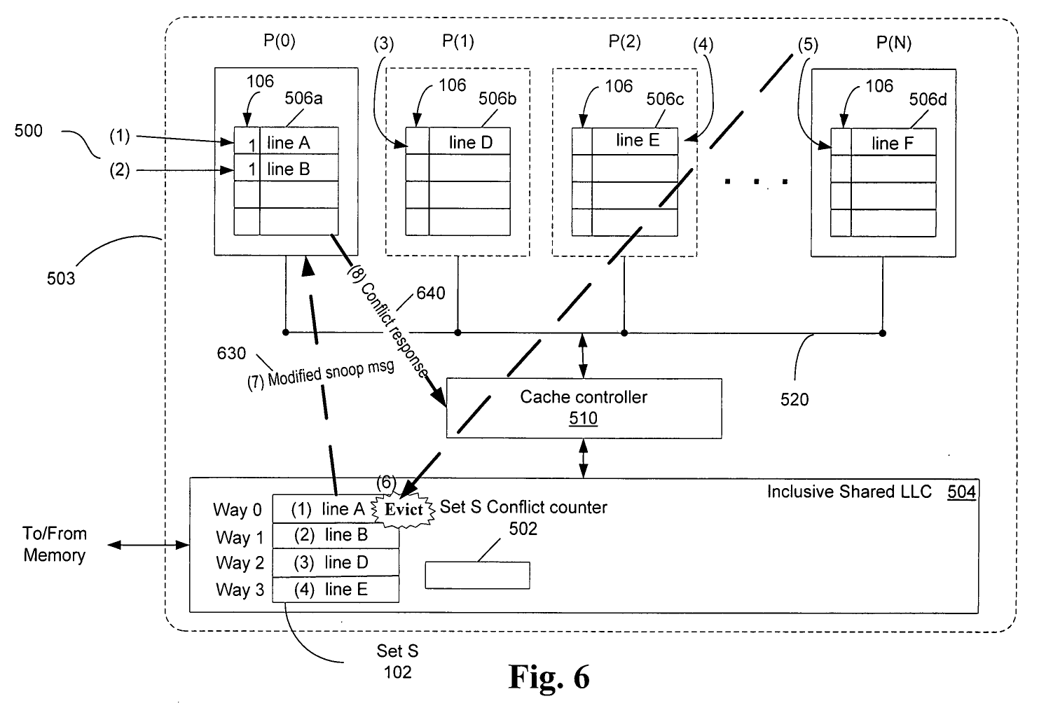

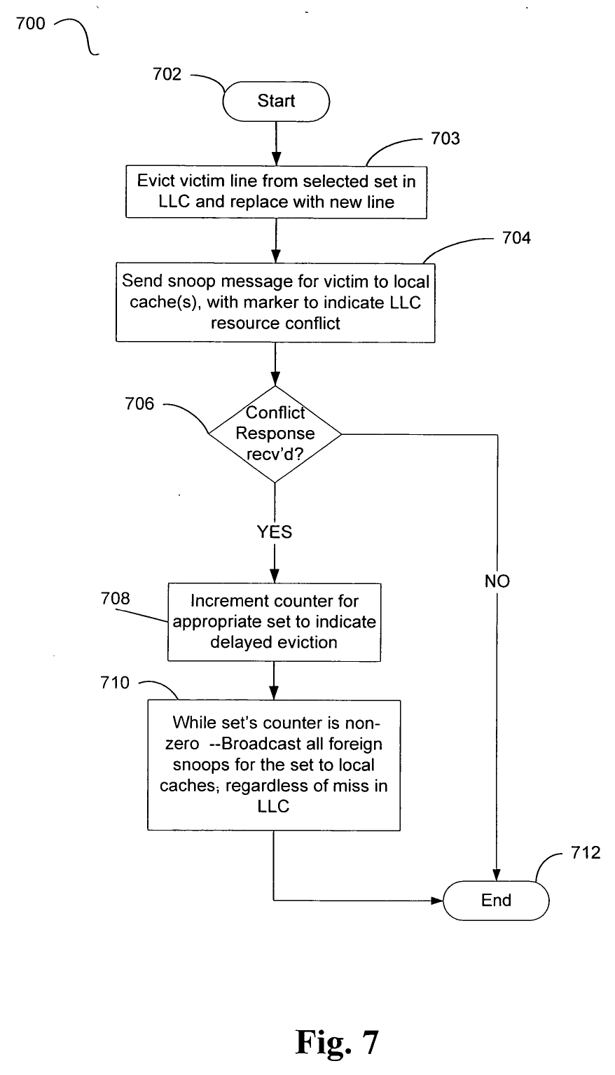

Further discussion of the delayed eviction scheme is presented in conjunction with FIG. 6 and FIG. 7. FIG. 6 is a block data flow diagram showing sample cache operations during operation of the system 500 illustrated in FIG. 5, where at least one processor is performing transactional execution of an atomic block of instructions. For the example illustrated in FIG. 6, assume that processor core P(0) is executing the code for transaction XYZ set forth above and also assume that each of the other processors are concurrently executing code as specified regard in connection with FIG. 4:
Processor core P(1): Write M
Processor core P(2): Write N
Processor core P(N): Write P

Cache operations (1) through (4) of FIG. 6 are substantially as those described above in connection with FIG. 4. At the end of cache operation (4), lines A, B, D and E have been loaded into the ways of set S in the LLC 504 as illustrated in FIG. 6.

FIG. 6 illustrates that, at cache operation (5), processor P(N) executes it instruction, causing a cache operation to pull cache line F into the local cache 206d in order to write data item P. Cache operation (5), executed as the result of execution of the “Write P” on processor P (N), encounters a full set 102 of the LLC 202. Accordingly a victim cache line is selected for eviction as a result of cache operation (5). FIG. 6 illustrates that, for purposes of example, the LLC replacement algorithm of the cache controller 510 selects Way 0, containing cache line A, to be evicted.

FIG. 7 is a flowchart illustrating at least one embodiment of a method 700 for relaxing the inclusion principle in the last-level cache for a set. An embodiment of such a method 700 may be performed, for example, by a cache controller (see, e.g., 510 of FIGS. 5 and 6). The method begins at block 702 and proceeds to block 703.

FIG. 6 and FIG. 7 illustrate that the cache controller 510 may, at block 703, evict the selected victim cache line. FIG. 6 illustrates the eviction of line A from the LLC 504 as cache operation (6). However, in contrast with the processing illustrated in FIG. 4, such eviction (6) does not necessarily cause an immediate eviction of cache line A from the local cache 506a of processor P(0). Processing then proceeds to block 704.

At block 704, the cache controller 510 may send a modified snoop request 630 for cache line A to processor P(0). Rather than simply indicating that processor core (P0) should evict the cache line, the modified snoop message 630 carries with it a marker to inform processor core (P0) that the snoop is due to an LLC resource conflict (and therefore does not reflect a data conflict with a cooperative thread). Sending 704 of the modified snoop message 630 is indicated in FIG. 6 as cache operation (7).

In response to the modified snoop message 630, control logic of the local cache 206a generates a response, at cache operation (8), to indicate that processor P(0) is performing transactional execution related to that cache line. Such response is referred to herein as a transaction set conflict response. Rather than immediately evicting the cache line and aborting the transaction, processor P(0) sends the transaction set conflict response 640 from the processor P(0) back to the cache controller 510 and continues with its transactional execution. The transaction set conflict response 640 indicates that processor P(0) will delay eviction of cache line A until after the transaction (for our example, transaction XYZ) has completed (or aborted). The transaction set conflict response 640 also triggers inclusion relaxation for set S 102, as is described immediately below.

The cache controller 510 receives the transaction set conflict response 640, causing the determination at block 706 of FIG. 7 to evaluate to “true.” Processing then proceeds to block 708.

If, on the other hand, a conflict transaction response is not received, the block 706 determination evaluates to false, indicating normal inclusive cache processing. It is assumed, in such case, that 1) the cache line has been evicted from the local cache 206a, 2) delayed eviction is therefore not to be performed, and 3) inclusive cache processing may proceed as normal. Accordingly, if the determination at block 706 evaluates to “false,” processing for the method 700 ends at block 712.

FIG. 6 illustrates that cache line A was evicted from the LLC 504 at cache operation (6), but that the eviction of the cache line from local cache 206a did not occur at cache operation (7). Instead, a transaction set conflict response 640 was sent at cache operation (7), indicating that eviction of the cache line from the local cache 206a will be delayed.

As a result of cache operations (6) and (7), the LLC 504 is no longer inclusive as to set S. That is, local cache 206a has a valid cache line, line A, that is not included in set S of the LLC 504. Accordingly, at block 708 of FIG. 7, the cache controller 510 begins to execute relaxed inclusion processing for set S in the LLC 504.

At block 708 the cache controller 510 increments the value of the conflict counter 502 for set S. Processing then proceeds to block 710. At block 710, the cache controller 510 enters a relaxed inclusion mode for the selected set (in our example, set S). For any foreign snoop of the selected set, the cache controller 510 broadcasts the snoop, at block 710, to all local caches 206a-206d. That is, as long as the conflict count for a set is non-zero, the cache controller 510 is on notice that one of the local caches has indicated that it will delay eviction due to a transaction, and that the inclusion principle for that set is not currently being followed. The processing at block 710 effectively allows non-inclusion on a per-set basis as long as one or more delayed evictions are pending for that set. Processing of the method 700 then ends at block 712.

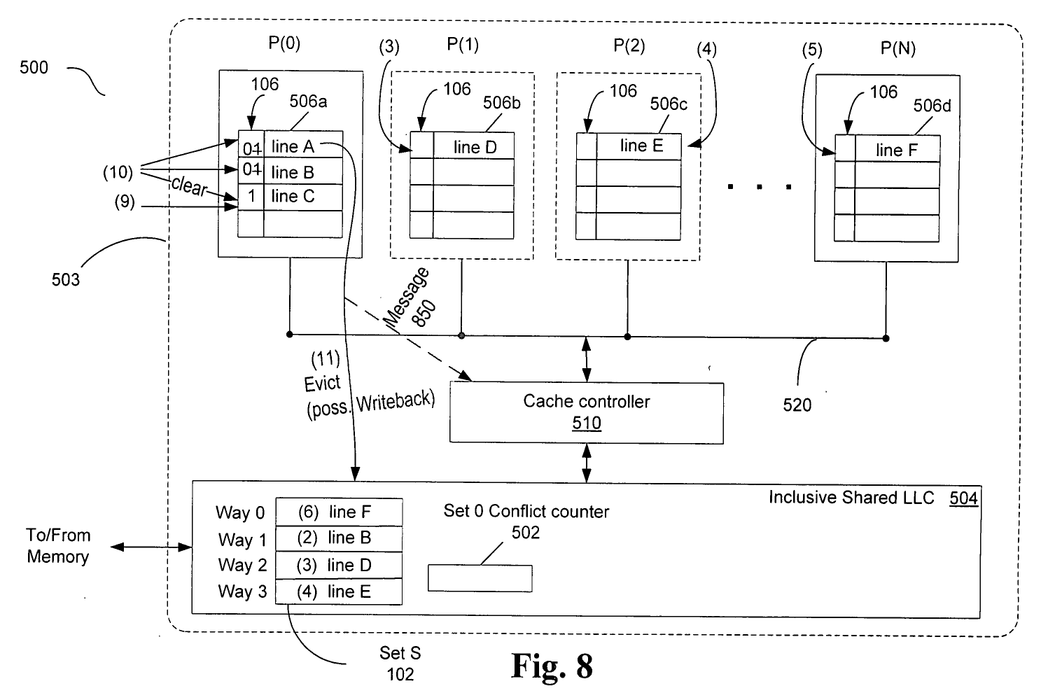

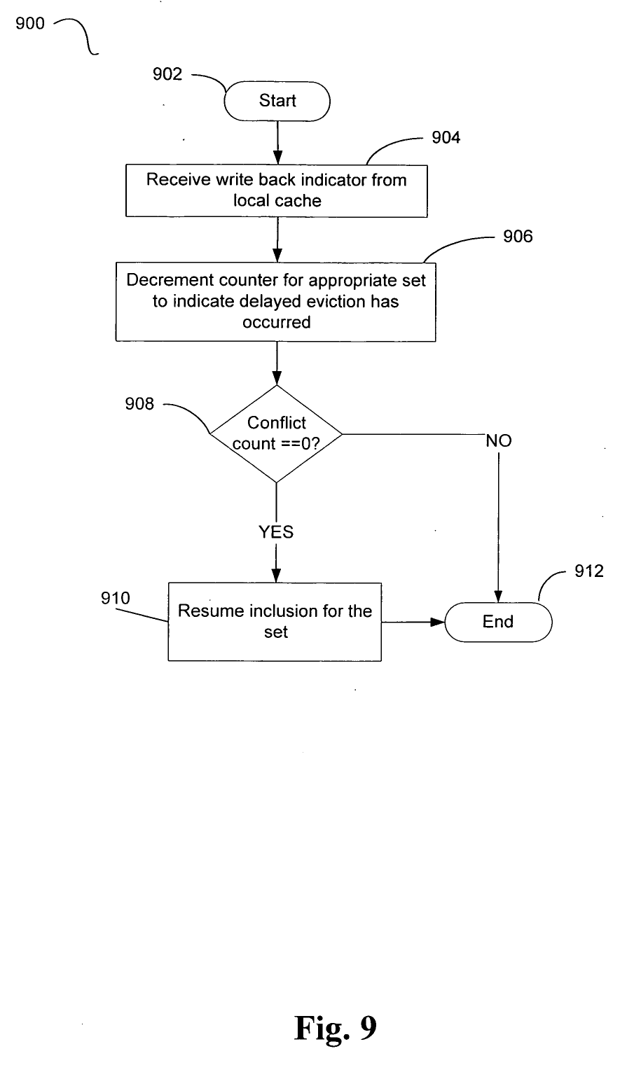

FIGS. 8 and 9 illustrate processing that may be performed, according to at least one embodiment of the invention, in order to restore inclusion for a set that has experienced delayed eviction from a local cache. FIG. 8 is a block data flow diagram illustrating data flow for an embodiment of a multi-processor system such as that 500 illustrated in FIG. 5. FIG. 9 is a flowchart illustrating at least one embodiment of a method 900 for resuming inclusion for a set that has experienced delayed eviction. For at least one embodiment, the method 900 of FIG. 9 may be performed by a cache controller such as cache controller 510 illustrated in FIGS. 5 and 6.

FIG. 8 continues the example discussed above in connection with FIGS. 6 and 7. FIG. 8 illustrates that, after cache operation (6), Way 0 of set S of the LLC 504 has been replaced with cache line F. At cache operation (9), processor core (P0) brings a line of memory containing data item Z into the local cache 206a during continued execution of transaction XYZ. The line is referred to in FIG. 8 as cache line C. The transaction bit in field 106 is set for cache line C to indicate that it contains interim data.

After execution of transaction XYZ is completed, if the transaction has been successful, the processor P(0) commits the memory state of the transaction. The transaction bits for cache lines A, B and C are cleared at cache operation 10. When it commits the memory state for transaction XYZ, processor P(0) writes item X back to the LLC 504 and performs a delayed eviction of cache line A. If the transaction was not successful, the processor P(0) evicts cache line A from the local cache 206a without committing the results. The write-back and eviction (transaction was successful) or eviction (transaction XYZ was not successful) is illustrated as cache operation (11) in FIG. 8.

Whether the transaction was successful or not, processor P(0) sends a message 850 to the cache controller around the same time that it performs cache operation (11). The message 850 is to indicate that the processor P(0) has completed performance of a delayed eviction or writeback. The message is referred to herein as a completion message 850. The completion message 850 may be generated and sent by control logic associated with the local cache 506a.

FIG. 9 illustrates that the cache controller may receive the completion message at block 904. From block 904, processing for the method 900 proceeds to block 906. At block 906, the cache controller 510 decrements the conflict counter 502 for set S. Processing then proceeds to block 908, where it is determined whether the conflict counter for the selected set is now non-zero as a result of the decrement. If not, then the set remains in a non-exclusion state, and processing ends at block 912.

If, however, it is determined at block 908 that the conflict counter for the set reflects a value of zero, then no further delayed evictions are pending for the set. As a result, processing proceeds to block 910, where normal inclusion processing is resumed for the selected set. Processing then ends at block 912.

The mechanisms, methods, and structures described above may be employed in any multi-processor system. Some examples of such systems are set forth in FIGS. 2, 5, 6 and 8, discussed above. Embodiments of each of such systems may include a plurality of processors that each implements a non-blocking cache memory subsystem (the cache memory subsystem will sometimes be referred to herein by the shorthand terminology “cache system”). The cache system may include an L0 cache 206, 506 and may optionally also include an L1 cache (not shown). For at least one embodiment, the L0 cache 206, 506 (and L1 cache, if present) may be on-die caches. The systems may also include an on-die shared last-level cache 204, 504.

In addition to the caches, each processor of the system may also retrieve data from a main memory (see, e.g., main memory 590 of FIG. 5). The main memory, L2 cache, L0 cache, and L1 cache, if present, together form a memory hierarchy. The memory (see, e.g., main memory 590 of FIG. 5) may store instructions 592 and/or data 591 for controlling the operation of the processors. The instructions 592 and/or data 591 may include code for performing any or all of the techniques discussed herein. Memory 590 is intended as a generalized representation of memory and may include a variety of forms of memory, such as a hard drive, CD-ROM, random access memory (RAM), dynamic random access memory (DRAM), static random access memory (SRAM), etc, as well as related circuitry.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

Systems 200 and 500 discussed above are representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, engineering workstations, set-top boxes and the like) may also be used. In one embodiment, sample system may be executing a version of the WINDOWS® operating system available from Microsoft Corporation, although other operating systems and graphical user interfaces, for example, may also be used.

While particular embodiments of the present invention have been shown and described, it will be obvious to those skilled in the art that changes and modifications can be made without departing from the scope of the appended claims. For example, the set replacement algorithm implemented by the cache controller 510 illustrated in FIGS. 5, 6 and 8 may be biased toward favoring transactional cache block. That is, they replacement algorithm may decline to displace transactional blocks from the LLC if a non-transactional block is available. In such a manner, the replacement algorithm may help reduce transitions into the non-inclusive inclusive discussed above in connection with block 710 of FIG. 7. One of skill in the art will realize that such alternative embodiment may require that the LLC and the local caches exchange additional information regarding which cache blocks contain interim data.

Also, for example, one of skill in the art will understand that embodiments of the delayed eviction/ relaxed inclusion structures and techniques discussed herein may be applied in any situation for which delayed writeback or delayed eviction is desirable. Although such approach is illustrated herein with regard to its usefulness vis-à-vis transactional execution, such discussion should not be taken to be limiting. One of skill in the art may determine other situations in which the techniques discussed herein may be useful, and may implement delayed eviction/relaxed inclusion for such situations without departing from the scope of the claims below.

Also, for example, the value of a per-set counter 502 is discussed above as the means for determining if delayed evictions are pending. However, one of skill in the art will recognize that other approaches may be utilized to track pending delayed evictions.

Also, for example, the embodiments discussed herein may be employed for other situations besides those described above, including situations that do not involve transactional execution. For example, the embodiments may be employed for a system that provides a Quality-of-Service provision for a first thread in order to ensure that other threads in the system do not degrade the first thread's performance.

Accordingly, one of skill in the art will recognize that changes and modifications can be made without departing from the present invention in its broader aspects. The appended claims are to encompass within their scope all such changes and modifications that fall within the true scope of the present invention.

What is claimed is:

1. An apparatus, comprising:
a plurality of processors, each having a local cache;
a shared inclusive cache coupled the processors; and
a cache controller to place a set of the shared cache into a non-inclusive state, responsive to a delayed eviction indicator from one of the processors.

2. The apparatus of claim 1, further comprising:
a storage area to track pending delayed evictions.

3. The apparatus of claim 2, wherein:
said storage area is to maintain a counter value.

4. The apparatus of claim 3, wherein:
said cache controller is further to decrement the value of said counter value responsive to receipt of the delayed eviction indicator

5. The apparatus of claim 2, further comprising:
a plurality of said storage areas, each corresponding to a set of the shared cache.

6. The apparatus of claim 1, wherein:
said cache controller is further to, during said non-inclusive state, broadcast a snoop for the set to the local caches, regardless of whether the snoop hits in the shared cache.

7. The apparatus of claim 1, wherein said local caches further include:
control logic to generate the delayed eviction indicator.

8. The apparatus of claim 7, wherein:
said control logic is further to generate the delayed eviction indicator responsive to a snoop that would otherwise cause an interim datum to be evicted from the local cache during transactional execution.

9. The apparatus of claim 1, wherein said local caches further include:
control logic to generate a message to indicate completion of a delayed eviction.

10. The apparatus of claim 1, wherein said cache controller is further to:
place the set into an inclusive state, responsive to a determination that all pending delayed evictions for the set have been completed.

11. A cache controller, comprising:
control module to selectively broadcast snoops to a plurality of local caches while in an inclusive mode;
mechanism to increment a counter upon receipt of a delayed eviction indicator from one of the local caches; and
mechanism to decrement the counter upon receipt of a completion message from the local cache;
wherein said control module is further to place a selected set, associated with the delayed eviction indicator, into a non-inclusive mode while the counter value indicates that one or more delayed evictions are pending for the set.

12. The cache controller of claim 11, wherein:
said control module is further to non-selectively broadcast snoops for the set to all of the local caches during said non-inclusive mode.

13. The cache controller of claim 11, wherein:
said control module is further to broadcast said snoops, while in the inclusive mode, to the local caches only if the snoop hits in a shared cache.

14. The cache controller of claim 11, wherein:
said control module is further to maintain said inclusive mode for all sets, except the selected set, of a shared cache.

15. The cache controller of claim 11, further comprising:
module to select and evict data from a shared cache according to a replacement policy.

16. The cache controller of claim 15, wherein:
said control module is to maintain the non-inclusive mode for the selected set while one of the local caches delays eviction of the data.

17. A system, comprising:
a memory;
a plurality of processors coupled to the memory, each processor including a local cache;
a shared cache coupled between the processors and the memory; and
cache control logic to enforce a coherence policy among the local caches, shared cache, and memory;
wherein said cache control logic includes logic to implement the shared cache as an inclusive cache, and also includes logic to temporarily treat one or more sets of the shared cache as non-inclusive.

18. The system of claim 17 wherein:
said memory is a DRAM.

19. The system of claim 17, further comprising:
a counter to track pending delayed evictions for a set of the shared cache.

20. The system of claim 17, wherein all of said processors resides on a single chip.

21. The system of claim 20, further comprising:
a second plurality of processors, on a second chip, coupled to the single chip.

22. The system of claim 19, wherein:
said logic to temporarily treat one or more sets of the shared cache as non-inclusive further comprises logic to treat a set as non-inclusive while the counter value indicates that one or more delayed evictions is pending for the set.

23. The system of claim 21, wherein said logic to implement the shared cache as an inclusive cache further comprises:
logic to broadcast a snoop from the second chip to the local caches only if the snoop hits in the shared cache.

24. The system of claim 21, wherein said logic to temporarily treat one or more sets of the shared cache as non-inclusive further comprises:
logic to broadcast any snoop from the second chip, if the snoop maps to the one or more sets, to the one or more local caches.
